(19) United States
(12) Patent Application Publication
(10) Pub. No.: US 2015/0118355 A1
(43) Pub. Date: Apr. 30, 2015

(54) Brewing Method

(71) Applicant: Novozymes A/S, Bagsvaerd (DK)

(72) Inventors: Lone Baekgaard, Frederiksberg (DK); Hans Peter Heldt-Hansen, Virum (DK); Ole Olsen, Copenhagen (DK); Lene Molskov Bech, Smorum (DK)

(21) Appl. No.: 14/399,250

(22) PCT Filed: May 7, 2013
(86) PCT No.: PCT/EP2013/059456

§ 371 Date: Nov. 6, 2014

Related U.S. Application Data
(60) Provisional application No. 61/646,482, filed on May 14, 2012.

(30) Foreign Application Priority Data
May 11, 2012 (EP) 12167720.7

(51) Int. Cl. C12C 7/04

(52) U.S. Cl. CPC C12C 7/04
USPC 426/29

(57) ABSTRACT

This invention relates to wort making for brewing and non alcoholic beverages. More particularly it relates to methods for preparing a wort comprising a high level of free amino acids employing use of various enzymes including different exogenous proteases, for example an endoprotease and an exopeptidase.

### REFERENCE TO SEQUENCE LISTING

This application contains a Sequence Listing in computer readable form. The computer readable form is incorporated herein by reference.

### FIELD OF THE INVENTION

This invention relates to wort making for brewing and non alcoholic beverages. More particularly it relates to methods for preparing barley-based beverages employing use of various enzymes including different exogenous proteases.

### BACKGROUND OF THE INVENTION

One important step in beer brewing is fermentation of wort by yeast, which requires the presence of yeast nutritional compounds including sugar and nitrogen. The sources of wort nitrogen that are assimilable by yeast are mainly amino acids, ammonium ions and to a lesser extent di- and tripeptides. These substances are partly formed during malting, and partly during mashing due to various enzymatic activities, e.g. including the action of barley proteases on storage proteins of the hordein class (O'Connor-Cox and Ingledew, 1989, ASBC Journal, vol. 47, 102-108).

Amino acids are differentially absorbed by yeast, which has led to the following categorization of amino acids.

| | |
|---|---|
| Group A - Fast absorption | Glu, Asp, Asn, Gln, Ser, Thr, Lys, |
| | Arg |
| Group B - Intermediate absorption | Val, Met, Leu, Ile, His |
| Group C - Slow absorption | Gly, Phe, Tyr, Trp, Ala |
| Group D - Little or no absorption | Pro |

Wort nitrogen is sometimes determined as FAN (free amino nitrogen). FAN includes all free primary amines and thus also includes amines of nucleotides and other compounds which are not amino acids.

Various enzymes have been produced to aid preparation of a wort from 100% barley—i.e. in the absence of malt—which is still suitable for brewing. An example of such an enzyme mixture is Ondea Pro™ (Novozymes A/S, Denmark). Ondea Pro comprises the following enzyme activities:

Starch degrading activity

Protein degrading activity

Cell wall degrading activity

Lipid degrading activity

Wort prepared from 100% barley using Ondea Pro comprises 9-14 mg/L/Plato FAN and shows fermentation performance comparable to that of a malt-based wort, which largely falls within the lower range of the recommended 10-18 mg/L/Plato (Aastrup, 2010, Scandinavian Brewer's Review, vol. 67, p. 28-33).

WO2009/074650 describes a process for the production of a brewer's wort comprising an enzymatic treatment of a grist comprising up to 100% unmalted grain. The process comprises contacting a mash with exogenous enzymes comprising an alpha-amylase activity, a pullulanase activity, a proteolytic activity, a lipolytic activity and a β-glucanase activity. Depending on the proteolytic activity, a FAN level of up to around 10 mg/L/Plato is achieved in 100% barley wort.

JP2008109861 describes a method for production of wort characterised by use of a protease with reduced amount of endoprotease and increased amount of exopeptidase. The endoprotease may be serine type alkaline protease, neutral metal protease I or neutral metal protease II. The exopeptidase may be leucine aminopeptidase, phenylalanine aminopeptidase or X-prolyl dipeptidyl aminopeptidase.

### SUMMARY OF THE INVENTION

In one aspect, the invention relates to a method of preparing a wort comprising a high level of free amino acids, said method comprising the steps of
a) mashing a composition comprising barley in the presence of exogenous enzymes comprising an alpha amylase, a beta glucanase, a pullulanase, a xylanase, and a lipase; and
b) adding to said composition during mashing or after completion of mashing at least two different exogenous proteases, wherein one protease has endoprotease activity, and the other protease has exopeptidase activity.

In one aspect, the exogenous proteases are added to the wort.

In one aspect, the wort is converted into beer.

In one aspect, the invention relates to use of at least 2 different exogenous proteases in wort making.

In one aspect, the protease having endoprotease activity is a metalloprotease.

In yet another aspect, the metalloprotease is a protease having 60% identity to SEQ ID NO: 1.

In another aspect, the protease having endoprotease activity is a proline and/or glutamine endoprotease.

In one aspect, the protease having exopeptidase activity has proline specific activity.

In another aspect, the protease having exopeptidase activity has carboxy proline specific activity.

In yet another aspect, the protease having exopeptidase activity has aminopeptidase activity.

In yet another aspect, the protease having exopeptidase activity has carboxypeptidase activity.

In one aspect, the wort produced comprises a high level of free amino acids that include the aliphatic amino acids.

In another aspect, the wort produced comprises a high level of free amino acids that belong to group B, i.e., intermediate adsorbed amino acids.

In yet another aspect, the wort produced comprises a high level of free amino acids including but not limited to valine, isoleucine and/or leucine.

### DETAILED DESCRIPTION OF THE INVENTION

Brewing processes are well-known in the art, and generally involve the steps of malting, mashing, and fermentation. Mashing is the process of converting starch from the milled barley malt and solid adjuncts into fermentable and unfermentable sugars to produce wort of the desired composition. Traditional mashing involves mixing milled barley malt and adjuncts with water and incubating at a set temperature and volume to continue the biochemical changes initiated during the malting process. The mashing process is conducted over a period of time at a constant temperature (isothermal mashing) or gradually increased for example, in a sequential manner to various temperatures in order to activate the endogenous enzymes responsible for the degradation of proteins and carbohydrates. By far the most important change brought about in mashing is the liberation of soluble substances in the malt/barley/adjuncts into the liquid fraction and the conversion of starch molecules into fermentable sugars.

The principal enzymes responsible for starch conversion in a traditional mashing process are alpha-amylases, beta-amylases and dextranases. Alpha-amylase very rapidly reduces insoluble and soluble starch by splitting starch molecules into many shorter chains that can be attacked by beta-amylase. The disaccharide produced is maltose. In addition to the maltose formed during mashing short branched glucose oligomers are produced. The short branched glucose oligomers are non-fermentable sugars and add to the taste as well as the amount of calories of the finished beer.

After mashing when all the starch has been broken down, it is necessary to separate the liquid extract (the wort) from the residual solids (spent grains), for example, by filtration. Wort separation, lautering, is important because the solids contain large amounts of protein, poorly modified starch, fatty material, silicates, and polyphenols (tannins). Prior to lautering, the mash temperature may be raised to about 75-78° C. (165-173° F.) (known as mashing-off). The wort thus obtained may also be denoted “first wort”. The extract retained in the spent grain after collection of the first wort may also be washed out by adding hot water on top of the lauter cake. This process is called sparging. The hot water flows through the spent grain and dissolves the remaining extract. The diluted wort is called second wort and its extract decreases from the original gravity of the first wort down to, for example, 1-2%. Non-limiting examples of suitable procedures for preparation of wort is described for example, by Briggs et al., “Malting and brewing science, Volume I Malt and sweet wort”, Chapman and Hall, New York, USA, ISBN 0412165805 (1981) and Hough et al., “Malting and brewing science, Volume II Hopped wort and beer”, Chapman and Hall, New York, USA, ISBN 0412165902 (1981).

After addition of hops, the wort is boiled. Hereby numerous substances including several proteins are denatured and a precipitation of polyphenols will take place. After cooling and removal of precipitates, the wort may be aerated and fermented with brewer's yeast to produce a beer. After a main fermentation, lasting typically 5-10 days, most of the yeast is removed and a so-called green beer is obtained. The green beer is stored at a low temperature, typically at 0-5° C. for 1 to 12 weeks. During this period the remaining yeast will precipitate together with polyphenols. To remove the remaining excess polyphenols a filtration is performed to obtain the fermented beer. The fermented beer may be carbonized prior to bottling. Carbon dioxide not only contributes to the perceived “fullness” or “body” and as a flavor enhancer, it also acts as an enhancer of the foaming potential and plays an important role in extending the shelf life of the product. Further information on conventional brewing processes may be found in “Technology Brewing and Malting” by Wolfgang Kunze of the Research and Teaching Institute of Brewing, Berlin (VLB), 2nd revised Edition 1999, ISBN 3-921690-39-0.

The present inventors have surprisingly found that wort prepared from unmalted barley—even if treated with an enzyme mixture like Ondea Pro (available from Novozymes A/S)—comprises very low levels of free amino acids. Interestingly, the present inventors furthermore found that it is advantageous to increase the level of free amino acids in wort and in particular in wort prepared from unmalted barley. The increased levels of free amino acids result in significantly improved yeast growth.

In addition, the inventors have surprisingly found that increasing the level of both proline, which is a Group D amino acid with little or no absorption by yeast during fermentation and other free amino acids is advantageous, in particular when wort is prepared from unmalted barley.

In addition the inventors have surprisingly found that using two different exogenous proteases according to the methods of the invention result in increased level of free amino acids but does not affect the foam stability of the beer produced.

Thus, in one aspect, the invention relates to a method of preparing a wort comprising a high level of free amino acids, said method comprising the steps of
a) mashing a composition comprising barley in the presence of exogenous enzymes comprising an alpha amylase, a beta glucanase, a pullulanase, a xylanase, and a lipase; and
b) adding to said composition during mashing or after completion of mashing at least two different exogenous proteases, wherein one protease has endoprotease activity, and the other protease has exopeptidase activity.

As used herein, “a” can mean one or more, depending on the context in which it is used.

The term “wort” is understood as the unfermented liquid run-off following extracting the grist during mashing.

The term “grist” is understood as the starch or sugar containing material that is the basis for beer production, for example, but not limited to barley malt and the adjunct. Generally, the grist does not contain any added water.

The term “malt” is understood as any malted cereal grain, in particular, barley.

The term “adjunct” is understood as that part of the grist which is not malt. The adjunct may be any starch rich plant material such as, but not limited to, maize, rice, sorghum, and wheat and also includes readily fermentable sugar and/or syrup. The starch of some of the adjuncts has a relatively low gelatinization temperature which enable them to be mashed in together with the malt, whereas other adjuncts such as rice, corn and sorghum have a higher gelatinization temperature, such adjuncts are typically separately cooked and liquefied with an alpha-amylase before they are added to the mash. The adjuncts can be gelatinized prior to mashing or they can be added as such to the grist.

In one aspect, the adjuncts are not gelatinized prior to mashing.

The term “mash” is understood as a starch containing slurry of the grist comprising crushed barley malt, crushed unmalted grain, other starch containing material, or a combination thereof, steeped in water to make wort. “Mashing” is the process of converting starch in the mash into fermentable and un-fermentable sugars.

The term “beer” is here understood as fermented wort, i.e. an alcoholic beverage brewed from barley malt, optionally adjunct and hops. The term “beer” as used herein is intended to cover at least beer prepared from mashes prepared from unmalted cereals as well as all mashes prepared from malted cereals, and all mashes prepared from a mixture of malted and unmalted cereals. The term “beer” also covers beers prepared with adjuncts, and beers with all possible alcohol contents.

Conventional machinery, equipments and materials can be used during mashing. The grist is mixed with water prior to mashing. The water may preferably, before being added to the grist, be preheated in order for the mash to attain the desired mash temperature at the moment of mash forming. If the temperature of the formed mash is below the desired mashing temperature additional heat is preferably supplied in order to attain the desired process temperature. Preferably, the desired mashing temperature is attained within 15 minutes, or more preferably within 10 minutes, such as within 9, 8, 7, 6, 5, 4, 3, 2 minutes or even more preferably within 1 minute after the mash forming, or most preferably the desired mashing temperature is attained at the mash forming. The mashing process generally applies a controlled stepwise increase in temperature, where each step favours one enzymatic action over the other, eventually degrading proteins, cell walls and starch. Mashing temperature profiles are generally known in the art.

The temperature profile of the mashing process may be a profile from a conventional mashing process wherein the temperatures are set to achieve optimal degradation of the grist dry matter by the malt enzymes.

The malt is preferably derived from one or more of the grains selected from the list comprising maize (Zea), barley (Hordeum), wheat (Triticum), rye (Secale), sorghum (Sorghum), millets (for example, Pennisetum, Setaria, Panicum, Eleusine), Oats (Avena), Tritordeum (a wheat-barley hybrid), Triticale (a rye-wheat hybrid) and rice (orzya). Preferably, the malt is barley malt. The grist may comprise malted grain.

The grist may preferably comprise adjunct such as unmalted maize, or other unmalted grain, such as barley, wheat, rye, oat, maize, rice, milo, millet and/or sorghum, or raw and/or refined starch and/or sugar containing material derived from plants like wheat, rye, oat, maize, rice, milo, millet, sorghum, potato, sweet potato, cassava, tapioca, sago, banana, sugar beet and/or sugar cane. The adjuncts may be obtained from tubers, roots, stems, leaves, legumes, cereals and/or whole grain. Preferred is adjunct obtained from maize and/or rice, more preferred the adjunct is maize. The mash preferably comprises from 1% to 80%, preferably from 5% to 80%, more preferably from 10% to 80%, and even more preferably from 30 to 80% adjunct starch, most preferably from 30-60%, and even most preferably from 40-60%.

The term “identity” or “sequence identity” is the relatedness between two amino acid sequences or between two nucleotide sequences. For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 5.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the −nobrief option) is used as the percent identity and is calculated as follows:

(Identical Residues×100)/(Length of Alignment−Total Number of Gaps in Alignment)

The term “exogenous” is used herein to denote compounds which are added to a particular composition, but which naturally do not form part of said composition. By way of example, isolated enzymes are considered exogenous when added to a barley extract such as wort.

The invention also provides methods for preparing a wort with high levels of free amino acids.

The invention also provides methods for preparing a barley based beverage using a wort with high levels of free amino acids.

The composition comprising barley according to the present invention may comprise any kind of barley. The barley may be malted or unmalted. It is, however, preferred that the wort or barley based beverage is prepared from barley wherein a large proportion of said barley is unmalted barley. Thus, it is preferred that said barley-based beverage or said wort is prepared from a composition comprising barley, wherein said barley consists of at the most 30% malted barley, preferably at the most 20% malted barley, even more preferably at the most 10% malted barley, yet more preferably said composition comprises no malted barley.

In addition to said malted and/or unmalted barley, the aforementioned composition may comprise one or more adjuncts. Thus, the composition may comprise one, such as 2, for example 3, such as 4, for example 5, such as more than 5 different adjuncts in addition to said barley. Said adjuncts are preferably carbohydrate-rich and may for example be selected from the group consisting of cereals other than barley, syrups and sugars, for example from the group consisting of maize and rice adjuncts. Said cereals other than barley may for example be selected from the group consisting of germinated or non-germinated cereals, wherein said cereals for example may be selected from the group consisting of wheat, rice, maize, rye, oat, sorghum, Tritordeum and Triticale, such as from the group consisting of wheat and rye.

Adjunct may also comprise readily fermentable carbohydrates such as sugars or syrups and they may be added to the malt mash before, during or after the mashing process of the invention but is preferably added after the mashing process.

Prior to forming the mash, the malt and/or adjunct are preferably milled and most preferably dry or wet milled.

In one aspect, the adjunct has a high gelatinization temperature, more particularly higher onset gelatinization temperature for, e.g., corn, rice and sorghum. In one aspect, the adjunct is gelatinized prior to mashing. In another aspect, the adjunct is not gelatinized prior to mashing.

In one aspect, the mash is comprised of at least 20% of adjuncts which have a starch gelatinization temperature, preferably onset gelatinization temperature, of at least 65° C. In another aspect, the mash is comprised of at least 25%, e.g. at least 30%, at least 35%, at least 40%, at least 45%, at least 50%, at least 55%, at least 60% such as at least 65% adjuncts which have a starch gelatinization temperature, preferably onset gelatinization temperature, of at least 65° C.

Preferably these adjuncts have high gelatinization temperature. More particularly, these adjuncts have a high onset gelatinization temperature.

In one aspect of the invention, the adjunct is a mixture comprising both high and low gelatinization temperature adjuncts.

When an aqueous solution of starch granules is heated, the granules swell to form a paste. This process is called “gelatinization”. The temperature at which gelatinization occurs is called the “gelatinization temperature”. Because of the complex nature of the starch in the adjuncts and also the conditions during mashing, the gelatinization actually occurs over a particular temperature range. The gelatinization temperature range thus can be characterised by the “onset gelatinization temperature”, the “peak gelatinization temperature” and the “conclusion gelatinization temperature”. For example, for corn starch, the onset gelatinization temperature is approximately 62° C. (peak: 67° C., conclusion: 72° C.), and for rice starch the onset gelatinization temperature is approximately 68° C. (peak: 74.5° C., conclusion: 78° C.) (Starch, 2nd ed. Industrial microscopy of starch by Eileen Maywald Snyder). The initial gelatinization temperature may vary according to the plant species, to the particular variety of the plant species as well as with the growth conditions.

Syrups may be any syrups, but it is preferred that said syrup contains maltose. The syrup may in preferred embodiments be syrup prepared from a cereal, such as barley syrup. The syrup may also be prepared from a malted cereal, such as barley, and accordingly the syrup may be barley malt syrup. It is preferred that the syrup contains in the range of 40 to 90% maltose apart from water.

The methods of preparing a wort comprising a high level of free amino acids according to the present invention comprise a step of mashing optionally in the presence of one or more exogenous enzymes. It is preferred that the mashing is performed in the presence of at least one, preferably at least 2, yet more preferably at least 3, even more preferably at least 4 exogenous enzymes. Said exogenous enzymes may be any of the enzymes described herein below in the section “Exogenous enzymes”.

In particular, in embodiments of the invention wherein said barley of said composition comprises a large proportion of unmalted barley, for example in embodiments of the invention wherein said barley consists of at the most 30% malted barley, preferably at the most 20% malted barley, even more preferably at the most 10% malted barley, yet more preferably said composition comprises no malted barley, then it is preferred that mashing is performed in the presence of at least one, preferably at least 2, yet more preferably at least 3, even more preferably at least 4 exogenous enzyme(s), even more preferably at least 5 exogenous enzyme(s), wherein said exogenous enzymes may be any of the exogenous enzymes described herein below in the section “Exogenous enzymes”.

Said exogenous enzymes may be added anytime at the mashing and/or before mashing, and thus the exogenous enzymes may be present during the entire mashing step or only during part of it. Thus, the exogenous enzymes may be added to the mash ingredients, e.g., the water and/or the composition comprising barley before, during or after forming the mash. It is preferred that said exogenous enzymes are added at the onset of mashing in order for them to be present during the entire mashing. The exogenous enzymes may be added together or separately.

The methods according to the invention also comprise use of at least two different exogenous proteases, which may be any of the exogenous proteases described herein below in the section “Exogenous proteases”. Said exogenous proteases may individually be added prior to or during mashing or after completion of mashing or to the wort obtained immediately after lautering or after heating of the wort. In embodiments of the invention, at least one, such as at least two, for example all of the different proteases may be added to the wort after heat treatment of the wort. They may also be added immediately after heat treatment. However, preferably they are added once the wort has been allowed to cool to a temperature, where said exogenous proteases are not heat-inactivated, such as to a temperature of at the most 80° C., such as at the most 70° C., such as at the most 60° C., such as at the most 50° C., such as at the most 40° C., for example at the most 30° C., such as at the most 20° C. In certain embodiments said proteases may be added simultaneously with the yeast at the onset of fermentation. In embodiments of the invention wherein the exogenous proteases are not heat stable it is preferred that they are added at the beginning of mashing or after completion of mashing, preferably after the step of heating of wort (see herein below). However they may also be added at the onset of mashing or during mashing or after mashing, which may be particularly relevant in embodiments of the invention wherein the exogenous proteases are heat stable. In preferred embodiments, the exogenous proteases may also be added at 2 different steps or time points in the brewing cycle, e.g., one or more proteases can be added during mashing while another or more can be added after completion of mashing.

Accordingly, in one embodiment of the invention wort is prepared using a method wherein the initial mashing temperature does not exceed 70° C., for example the initial mashing temperature may be in the range of 30° C. to 69° C., such as in the range of 35° C. to 65° C.

In a preferred embodiment of the invention the temperature during mashing does not exceed 80° C.

The wort obtained after mashing may also be referred to as “sweet wort”. In conventional methods, the sweet wort is boiled with or without hops where after it may be referred to as boiled wort.

Said wort may optionally be heated after mashing. The wort may be heated/boiled for any suitable amount of time, in general in the range of 60 min to 120 min, in order to evaporate at least 5% and some cases even up to 25% of the wort volume. Extended boiling may sometimes be undesirable for a number of reasons, for example because extended boiling requires pronounced energy supply.

The wort composition may also be barley wort. In general, a wort composition contains a high content of amino nitrogen and fermentable carbohydrates, the latter mainly being maltose.

The wort according to the present invention preferably has a high level of free amino acids. Said high level of free amino acids is preferably at level of at least 3 mM free amino acids.

The wort may in one embodiment be sweet wort, i.e. wort which has not been subjected to heat treatment. It is preferred that said sweet wort comprises at least 3 mM, such as at least 4 mM, such as at least 5 mM, such as at least 6 mM, such as at least 7 mM, such as at least 8 mM, such as at least 9 mM, such as at least 10 mM, such as at least 11 mM, such as at least 12 mM free amino acids.

Even in embodiments of the invention wherein said barley of said composition comprises a large proportion of unmalted barley, for example in embodiments of the invention wherein said barley consists of at the most 30% malted barley, preferably at the most 20% malted barley, even more preferably at the most 10% malted barley, yet more preferably said composition comprises no malted barley, then it is preferred that said sweet wort comprises at least 3 mM, such as at least 4 mM, such as at least 5 mM, such as at least 6 mM, such as at least 7 mM, such as at least 8 mM, such as at least 9 mM, such as at least 10 mM, such as at least 11 mM, such as at least 12 mM free amino acids.

The wort may also be boiled wort in which case the wort preferably comprises at least at least 3 mM, such as at least 4 mM, such as at least 5 mM, such as at least 6 mM, such as at least 7 mM, such as at least 8 mM, such as at least 9 mM, such as at least 10 mM, such as at least 11 mM, such as at least 12 mM free amino acids.

Amino acids may have very substantial effects on the quality of the final beer. For example, if valine is deficient, yeast usually synthesizes valine by a pathway involving acetolactate as an intermediate. Acetolactate can accumulate and be oxidatively broken down to diacetyl, which may contribute to an undesirable flavour. It is accordingly preferred that the wort according to the invention comprises a high level of free valine, in particular it is preferred that said wort comprises a high level of free valine after incubation with said at least two different exogenous proteases. Said high level of free valine is preferably at least 35 mg/L, such as at least 40 mg/L, such as at least 45 mg/L, such as at least 50 mg/L, such as at least 55 mg/L, such as at least 60 mg/L, such as at least 65 mg/L, such as at least 70 mg/L, such as at least 80 mg/L, for example at least 100 mg/L. In another aspect, it is preferred that the wort according to the invention comprises a high level of free isoleucine, in particular it is preferred that said wort comprises a high level of free isoleucine after incubation with said at least two different exogenous proteases. In another aspect, it is preferred that the wort according to the invention comprises a high level of free leucine, in particular it is preferred that said wort comprises a high level of free leucine after incubation with said at least two different exogenous proteases. In another aspect, it is preferred that the wort according to the invention comprises a high level of free group B amino acids, in particular it is preferred that said wort comprises a high level of free group B amino acids after incubation with said at least two different exogenous proteases.

One major advantage of the worts prepared according to the present invention is that said worts are superior in supporting growth of yeast compared to worts prepared by conventional methods.

In particular, it is preferred that the wort prepared according to the invention supports growth of yeast in a manner so that 28 h after inoculation of yeast to said wort, then said wort comprises at least 105%, such as at least 110%, for example at least 120%, for example at least 130% yeast cells/ml compared to a wort prepared in the same manner without addition of exogenous enzymes.

Thus, it is preferred that that the wort prepared according to the invention supports growth of yeast in a manner so that 28 h after inoculation of yeast at a density of 1×10⁵ cells/ml to said wort then said wort comprises at least 105%, such as at least 110%, for example at least 120%, for example at least 130% yeast cells/ml, compared to a wort prepared in the same manner without addition of exogenous enzymes.

Preferably, the beverages of the invention produce at least 100%, preferably at least 150%, such as at least 200% of the foam in 40 to 50 min compared to a normal Carlsberg Pilsner (available from Carlsberg Breweries, Denmark). Such a beverage according to the invention may in particular be a beverages prepared from a composition comprising barley, wherein all of said barley is unmalted.

In another preferred embodiment, a further enzyme(s) is added to the mash, said enzyme(s) including but not limited to alpha amylase, isoamylase, protease, cellulase, glucanase, laccase, xylanase, lipase, phospholipolase, phytase, pullulanase, and esterase.

In one aspect, the exogenous enzyme is alpha amylase.

In another aspect, the exogenous enzyme is beta glucanase.

In yet another aspect, the exogenous enzyme is pullulanase.

In another aspect, the exogenous enzyme is xylanase.

In yet another aspect, the exogenous enzyme is lipase.

The enzymes may be added as enzyme compositions. They may consist of one enzyme or more than one enzyme or more than one enzyme compositions. The enzyme composition, in addition to the enzyme(s), may also contain at least one other substance, for example but not limited to buffer, surfactants etc. The enzyme compositions may be in any art-recognized form, for example, solid, liquid, emulsion, gel, or paste. Such forms are known to the person skilled in the art. In one aspect of the invention more than one enzyme composition, each containing different enzymes may be added. In another aspect of the invention, one enzyme composition containing all the necessary enzymes may be added. In yet another aspect of the invention, one enzyme composition containing a few of the enzymes and at least one another composition containing some or all of the rest of the enzymes may be added. The enzymes may be added at the same time or in sequence one after another or even as a combination of two enzymes and one enzyme separately, one after the other.

During the mashing process, starch extracted from the grist is gradually hydrolyzed into fermentable sugars and smaller dextrins. Preferably the mash is starch negative to iodine testing, before extracting the wort. The mashing is finalized by mashing-off at temperature of 70° C. or more, preferably at least 71° C., at least 72° C., at least 73° C., at least 74° C., at least 75° C., at least 76° C. at least 77° C., at least 78° C., least 79° C., at least 80° C. and more preferably at least 81° C. or even at least 82° C. or more.

Obtaining the wort from the mash typically includes straining the wort from the spent grains, i.e. the insoluble grain and husk material forming part of grist. Hot water may be run through the spent grains to rinse out, or sparge, any remaining extract from the grist. Optionally the application of a thermostable cellulase in the process of the present invention results in efficient reduction of beta glucan level facilitating wort straining thus ensuring reduced cycle time and high extract recovery. Preferably the extract recovery is at least 80%, preferably at least 81%, more preferably at least 82%, even more preferably at least 83%, such as at least 84%, at least 85%, at least 86%, at least 87%, at least 88%, at least 89%, at least 90%, and most preferably at least 91%. The wort may be used as it is, or it may be concentrated and/or dried. The concentrated and/or dried wort may be used as brewing extract, as malt extract flavouring, for nonalcoholic malt beverages, malt vinegar, breakfast cereals, for confectionary etc

The wort may also be processed to be used as syrups. It may also be used to produce non alcoholic beverages. These processes are known to a person skilled in the art.

The wort may also be processed into non alcoholic beverages. One non limiting example is disclosed, for example, in WO 2010/106170.

The wort may also be fermented to beer. Preferred beer types comprise ales, strong ales, stouts, porters, lagers, bitters, export beers, malt liquors, happoushu, high-alcohol beer, low-alcohol beer, low-calorie beer or light beer. Fermentation of the wort may also include pitching the wort with a yeast slurry comprising fresh yeast, i.e. yeast not previously used for the invention or the yeast may be recycled yeast. The yeast applied may be any yeast suitable for beer brewing, especially yeasts selected from Saccharomyces spp. such as S. cerevisiae and S. uvarum, including natural or artificially produced variants of these organisms. The methods for fermentation of wort for production of beer are well known to the person skilled in the art.

The first step of producing beer from wort preferably involves heating said wort as described herein above, followed by a subsequent phase of wort cooling and optionally whirlpool rest. After being cooled, the wort is transferred to fermentation tanks containing yeast. Preferably, said yeast is brewer's yeast, Saccharomyces carlsbergensis. The wort will be fermented and matured for any suitable time period, in general in the range of 1 to 100 days. During the several-day-long fermentation process, sugar is converted to alcohol and CO2 concomitantly with the development of some flavor substances.

Accordingly, the methods according to the invention preferably comprises a step of incubating barley wort, which may be any wort as described herein above in the presence of at least one yeast capable of fermenting said wort. This step is preferably undertaken subsequent to heating of the wort. Said exogenous proteases may in a preferred embodiment of the invention be added before or during said incubation with yeast, preferably they are added at the onset of said incubation with yeast.

Said yeast may be any useful yeast capable of fermenting said wort, such as brewers yeast, e.g., Saccharomyces carlsbergensis.

As described herein above the wort prepared according to the methods of the invention is especially useful for supporting yeast growth. Accordingly, it is possible according to the methods of the invention to have a reduced fermentation time. Thus it is preferred that the incubation with yeast is performed for at the most 15 days, such as at the most 10 days.

After preparing the beer, the beer may be further processed, for example chilled. It may also be filtered and/or lagered—a process that develops a pleasant aroma and a less yeasty flavor. Also additives may be added. Furthermore, CO2 may be added. Finally, the beer may be pasteurized and/or filtered, before it is packaged (e.g. bottled or canned).

Silica hydrogel may be added to the fermented wort to increase the colloidal stability of the beer. The process may further include adding kieselguhr to the fermented wort and filtering to render the beer bright.

### Enzymes

Exogenous enzymes

As mentioned above, the wort composition may be prepared by mashing barley, or parts thereof, such as unmalted barley kernels, in particular milled, unmalted barley kernels, or parts thereof. Unmalted barley kernels contain only a limited amount of or even lack enzymes beneficial for wort production, such as enzymes capable of degrading cell walls or enzymes capable of depolymerising starch into sugars.

Thus, it is preferred that the methods according to the invention comprise a mashing step, wherein mashing is performed in the presence of one or more exogenous enzymes.

Said one or more exogenous enzymes are preferably selected from the group of cell wall degrading enzymes, starch degrading enzymes and lipid-degrading enzymes.

More preferably, said enzymes are added at the onset of mashing.

These enzymes may be provided individually in different compositions, or they may be mixed. In embodiments of the invention wherein the proteases are heat stable proteases, all of the enzymes may preferably be provided in one composition comprising all of the enzymes.

### Alpha-amylase (EC 3.2.1.1)

An alpha-amylase enzyme may also be exogenous, microbial and added to the processes and/or compositions of the invention. The alpha-amylase may be a Bacillus alpha-amylase. Well-known Bacillus alpha-amylases include alpha-amylase derived from a strain of B. licheniformis, B. amyloliquefaciens, and B. stearothermophilus. A preferable alpha amylase is an alpha-amylase from B. stearothermophilus having the amino acid sequence disclosed as SEQ ID NO: 3 in WO 99/19467 with the mutations: 1181*+G182*+N193F.

The alpha-amylase may be added in the range of 0.001 to 10 KNU, preferably 0.01 to 5 KNU, even more preferably between 0.1 to 2 KNU per gram of dry matter of the adjunct.

One Kilo Novo alpha amylase Unit (KNU) equals 1000 NU. One KNU is defined as the amount of enzyme which, under standard conditions (i.e. at 37° C.+/−0.05; 0.0003 M Ca2+; and pH 5.6) dextrinizes 5.26 g starch dry substance Merck Amylum solubile.

In a preferred aspect, the enzyme with alpha-amylase activity is an alpha-amylase of fungal origin, e.g. alpha-amylase from Aspergillus niger, or of bacterial origin, e.g. alpha-amylase from Bacillus, such as alpha-amylase derived from a strain of B. licheniformis, B. amyloliquefaciens, and B. stearothermophilus. Thus the alpha-amylase might be a bacterial alpha-amylase variant having increased thermostability at acidic pH and/or low Ca2+ concentration. The alpha-amylase activity in the mash may for example be 0.1-1.0 KNU(S)/g, such as 0.2-0.4 KNU(S)/g, for example 0.25-0.35 KNU(S)/g dry weight barley. In one embodiment of the invention, it is preferred that the alpha-amylase has alpha-amylase activity as described above and at least 50%, more preferably at least 60%, more preferably at least 70%, more preferably at least 80%, preferably at least 85%, more preferably at least 90%, preferably at least 91%, preferably at least 92%, preferably at least 93%, preferably at least 94%, more preferably at least 95%, preferably at least 96%, preferably at least 97%, more preferably at least 98%, and most preferably at least 99% identity to the amino acid sequence shown as SEQ ID NO:1 in international patent application WO99/19467. SEQ ID NO:1 of international patent application WO99/19467 is a variant of the B. stearothermophilus alpha-amylase with the mutations I181*G182*, N193F, described in WO99/19467 (and available as Termamyl® SC from Novozymes A/S, Denmark). The alpha-amylase may also be the alpha-amylase as defined in WO 99/19467 on page 3, line 18 to page 6, line 27. A preferred alpha-amylase is an alpha-amylase having an amino acid sequence with at least 90% such as at least 92%, at least 95%, at least 96%, at least 97%, at least 98%, or particularly at least 99% identity to SEQ ID NO: 4 in WO 99/19467 and having alpha-amylase activity. Another preferred alpha-amylase is the alpha-amylase of SEQ ID NO: 9 disclosed in WO 99/43794 or variants thereof. Contemplated variants and hybrids are described in WO 96/23874, WO 97/41213, and WO 99/19467. Specifically contemplated is an alpha-amylase (E. C. 3.2.1.1) from B. stearothermophilus having the amino acid sequence disclosed as SEQ ID NO: 3 in WO 99/19467 with the mutations: 1181*+G182*+N193F. Bacillus alpha-amylases may for example be added in the amounts of 1.0-1000 NU/kg dry weight barley, preferably from 2.0-500 NU/kg dry weight barley, preferably 10-200 NU/kg dry weight barley. Another particular alpha-amylase to be used in the processes of the invention may be any fungal alpha amylase, e.g., an alpha amylase derived from any ascomycetous fungus of the genus Aspergillus, and preferably from a strain of Aspergillus niger. Especially contemplated are fungal alpha amylases which exhibit a high identity, i.e., at least 50%, at least 55%, at least 60%, at least 65%, at least 70%, at least 75%, at least 80%, at least 85% or even at least 90% identity to the amino acid sequence shown as SEQ ID NO: 1 in WO 2002/038787. Fungal alpha-amylases may be added in an amount of 1-1000 AFAU/kg dry weight barley, preferably from 2-500 AFAU/kg dry weight barley, preferably 20-100 AFAU/kg dry weight barley.

Alpha-amylase activity may be measured in AFAU (Acid Fungal Alpha-amylase Units), which are determined relative to an enzyme standard. 1 AFAU is defined as the amount of enzyme which degrades 5.260 mg starch dry matter per hour under the below mentioned standard conditions.

Acid alpha-amylase, an endo-alpha-amylase (1,4-alpha-D-glucan-glucanohydrolase, E.C. 3.2.1.1) hydrolyzes alpha-1,4-glucosidic bonds in the inner regions of the starch molecule to form dextrins and oligosaccharides with different chain lengths. The intensity of color formed with iodine is directly proportional to the concentration of starch. Amylase activity is determined using reverse colorimetry as a reduction in the concentration of starch under the specified analytical conditions.

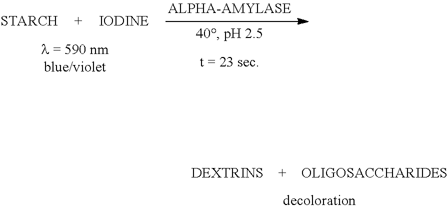

Standard Conditions/Reaction Conditions:
Substrate: Soluble starch, approx. 0.17 g/L
Buffer: Citrate, approx. 0.03 M
Iodine (I2): 0.03 g/L
CaCl2: 1.85 mM
pH: 2.50±0.05
Incubation temperature: 40° C.
Reaction time: 23 seconds
Wavelength: 590 nm
Enzyme concentration: 0.025 AFAU/mL
Enzyme working range: 0.01-0.04 AFAU/mL

### Pullulanase (E.C. 3.2.1.41)

The pullulanases used in the processes according to the present invention are preferably pullulanase from e.g. Pyrococcus or Bacillus sp, such as Bacillus acidopullulyticus (e.g., the one described in FEMS Microbiol. Letters 115: 97-106) or Bacillus deramificans, or Bacillus naganoencis. The pullulanase may also be an engineered pullulanases from, e.g., a Bacillus strain.

Other pullulanases which are preferably used in the processes according to the invention includes: Bacillus deramificans (U.S. Pat. No. 5,736,375), or the pullulanase may be derived from Pyrococcus Woesei described in PCT/DK91/00219, or the pullulanase may be derived from Fervidobacterium sp. Ven 5 described in PCT/DK92/00079, or the pullulanase may be derived from Thermococcus celer described in PCT/DK95/00097, or the pullulanase may be derived from Pyrodictium abyssei described in PCT/DK95/00211, or the pullulanase may be derived from Fervidobacterium pennavorans described in PCT/DK95/00095, or the pullulanase may be derived from Desulforococcus mucosus described in PCT/DK95/00098.

Most preferably the pullulanase is derived from Bacillus acidopullulyticus.

A preferred pullulanase enzyme to be used in the processes and/or compositions of the invention is a pullulanase having an amino acid sequence of Seq ID No. 3 disclosed in WO2009/075682.

In one aspect of the invention the pullulanase is at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identical to the sequence shown in Seq ID No: 3 of WO2009/075682.

In one aspect of the invention, the pullulanase is thermostable. An example of such a pullulanase is a pullulanase described in WO2009/075682.

For pullulanase, the thermostability is determined by finding the amount of activity of the enzyme that remains after incubating the enzyme in a buffer (pH 5) for 10 minutes both at 25° C. and at 64° C.

The pullulanase is added in dosage of 0.1 to 3 PUN/g dry matter (DM) adjunct, such as 0.2 to 2.9, such as 0.3 to 2.8, such as 0.3 to 2.7 such as 0.3 to 2.6 such as 0.3 to 2.5 such as 0.3 to 2.4, such as 0.3 to 2.3, such as 0.3 to 2.2, such as 0.3 to 2.1, such as 0.3 to 2.0, such as 0.3 to 1.9, such as 0.3 to 1.8, such as 0.3 to 1.7, such as 0.3 to 1.6, most preferably pullulanase is added in dosage such as 0.3 to 1.5, preferably 0.4 to 1.4, more preferably 0.5 to 1.3, more preferably 0.6 to 1.2, more preferably 0.7 to 1.1, more preferably 0.8 to 1.0, more preferably 0.9 to 1.0. In a particular embodiments of the invention the enzyme is added in 0.3 PUN/g DM adjunct, such as 0.4 PUN/g DM adjunct, such as 0.5 PUN/g DM adjunct, such as 0.6 PUN/g DM adjunct, such as 0.7 PUN/g DM adjunct. In a particularly preferred embodiment of the invention the enzymes dose is not larger than 1 PUN/g DM adjunct.

One pullulanase unit (PUN) is the amount of enzyme which, under standard conditions (i.e. after 30 minutes reaction time at 40° C. and pH 5.0; and with 0.2% pullulan as substrate) hydrolyzes pullulan, liberating reducing carbohydrate with a reducing power equivalent to 1 micromole glucose per minute.

Pullulanase activity is measured by detection of increased reducing sugar capacity (Somogyi-Nelson reaction) in the following conditions: Substrate: 0.2% pullulan, pH 5.0, reaction time 30 minutes. The samples are analyzed by spectrophotometer at OD 520 nm.

The exogenous enzyme with pullulanase activity is preferably a pullulanase. Said pullulanase may be any pullulanase known to the skilled person. In particular, the pullulanase may be any enzyme capable of catalysing hydrolysis of (1→6)-alpha-D-glucosidic linkages in pullulan, amylopectin and glycogen, and also in the limit dextrins of amylopectin and glycogen. Preferably, the pullulanase is any enzyme with EC number E.C. 3.2.1.41.

The pullulanase to be used with the present invention may be derived from Bacillus acidopullulyticus. A preferred pullulanase enzyme to be used in the methods and/or compositions of the invention is a pullulanase having an amino acid sequence, which is at least 50%, such as at least 55%, such as at least 60%, such as at least 65%, such as at least 66%, such as at least 70%, such as at least 75%, such as at least 80%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% or even 100% identical to the sequence shown in SEQ ID NO: 1 of international patent application WO2010/043538. The pullulanases used in the methods according to the present invention may in one embodiment preferably be a pullulanase, e.g., from Pyrococcus or Bacillus sp, such as Bacillus acidopullulyticus (e.g., the pullunase described in FEMS Microbiol. Letters 1 15: 97-106) or a pullulanase from Bacillus deramificans or B. naganoencis. The pullulanase may also be an engineered pullulanase, e.g., from a Bacillus strain.

Cellulase and/or Beta Glucanase:

The exogenous enzyme with beta-glucanase activity is preferably a (1-3, 1-4)-beta-glucanase or a cellulase, wherein cellulases also may be referred to as beta-glucanases. Said cellulases may be any cellulase known to the skilled person. In particular, the cellulase may be any enzyme capable of catalysing endohydrolysis of (1→4)-beta-D-glucosidic linkages in cellulose, lichenin and cereal beta-D-glucans. Preferably, the cellulase is any enzyme with EC number E.C. 3.2.1.4. Said (1-3, 1-4)-beta-glucanase may be any enzyme capable of catalysing endohydrolysis of (1→3)- or (1→4)-linkages in beta-D-glucans when the glucose residue whose reducing group is involved in the linkage to be hydrolysed is itself substituted at C-3. Preferably, the (1-3,1-4)-beta-glucanase is any enzyme with EC number EC 3.2.1.6.

The cellulase to be used with the present invention may be of microbial origin, such as a cellulase derived from a strain of a filamentous fungus (e.g., Aspergillus, Trichoderma, Humicola, Fusarium). Specific examples of cellulases useful with the present invention include the endoglucanase (endo-glucanase I) obtainable from H. insolens and further defined by the amino acid sequence of FIG. 14 in WO 91/17244 and the 43 kD H. insolens endoglucanase described in WO 91/17243. A particular cellulase to be used in the methods of the invention may be an endo-glucanase, such as an endo-(1-4)-beta-glucanase. Especially contemplated is the beta-glucanase shown in SEQ ID NO: 2 in WO 2003/062409 and homologous sequences. The added beta-glucanase activity may also origin from malt. In one particular preferred embodiment of the invention the beta-glucanase is added together with xylanase in an enzyme blend termed Ultraflo Max. Ultraflo Max is an enzyme blend of Xylanase and beta-glucanase, the blend is described in the application WO2005/059084. Commercially available cellulase preparations which may be used include CELLUCLAST®, CELLUZYME®, CEREFLO® and ULTRAFLO®(available from Novozymes A/S, Denmark), LAMINEX™ and SPEZYME®CP (available from Genencor Int.) and ROHAMENT®7069 W (available from Rohm, Germany). Cellulases may be added in the amounts of 1.0-10000 BGU/kg dry weight barley, preferably from 10-5000 BGU/kg dry weight barley, preferably from 50-1000 BGU/kg dry weight barley and most preferably from 100-500 BGU/kg dry weight barley.

One Beta Glucanase Unit (BGXU) corresponds to the quantity of enzyme required to produce 1 micromole of reducing sugars per minute under standard conditions (incubation at 30° C. for 10 minutes at pH 4.40).

One fungal beta glucanase unit (FBG) is the amount of enzyme, which, according to the standard conditions outlined below, releases reducible oligosaccharides or reduces carbohydrate with a reduction capacity equivalent to 1 mol glucose per minute. Fungal beta glucanase reacts with beta glucan during the formation process to glucose or reducing carbohydrate which is determined as reducing sugar according to the Somogyi Nelson method. The sample should be diluted to give an activity between 0.02˜0.10 FBG/ml. The standard reaction conditions are: Substrate: 0.5% barley beta glucan, temperature: 30° C., pH: 5.0 and the reaction time 30 min. However the cellulolytic activity in the commercial product is measured in endo-glucanase units (EGU), which can be converted to FBG. For celluclast the EGU can be converted to FBG by multiplying the EGU by a factor 3.2.

### Xylanase:

The exogenous enzyme with xylanase activity is preferably a xylanase. Said xylanase may be any xylanase known to the skilled person. In particular, the xylanase may be any enzyme capable of catalysing endohydrolysis of (1→4)-beta-D-xylosidic linkages in xylans. Preferably, the xylanase is an endo-1,4-beta-xylanase, such as any enzyme with EC number E.C. 3.2.1.4.

The xylanase may in one embodiment be any of the xylanases described in international patent application WO2005/059084 A1. In another embodiment, the xylanase activity is provided by a xylanase from glycosyl hydrolase family 10. Another preferred xylanase in any enzyme with xylanase activity having at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94% more preferably at least 95%, more preferably at least 96%, more preferably at least 97% more preferably at least 98%, and most preferably at least 99% or even 100% identity to the amino acid sequence shown in SEQ ID NO:4 of international patent application WO2009/074650 (described in WO 94/21785 and available as Shearzyme® from Novozymes A/S, Denmark). Preferably the xylanase activity is added to the mash at a concentration of 0.02-0.1 FXU-S/g, more preferably 0.04-0.08 FXU-S/g dry weight barley. The xylanolytic activity can be expressed in FXU(S)-units, determined at pH 6.0 with remazol-xylan (4-O-methyl-Dglucurono-D-xylan dyed with Remazol Brilliant Blue R, Fluka) as substrate. A xylanase sample is incubated with the remazol-xylan substrate. The background of non-degraded dyed substrate is precipitated by ethanol. The remaining blue colour in the supernatant (as determined spectrophotometrically at 585 nm) is proportional to the xylanase activity, and the xylanase units are then determined relatively to an enzyme standard at standard reaction conditions, i.e. Substrate concentration 0.45% w/v, Enzyme concentration 0.04-0.14 FXU(S)/mL at 50.0° C., pH 6.0, and in 30 minutes reaction time.

### Lipase:

The enzyme with lipase activity may be any enzyme with lipolytic activity, such as a lipase. In particular, the lipase may be a lipase having activity on triglycerides and/or galactolipids, lysophospholipids and/or phospholipids. Preferably, the lipase activity is provided by a lipase from Fusarium (including F. oxysporum and F. heterosporum), Aspergillus (including A. tubigensis), Rhizopus (including R. oryzae) or Thermomyces (including T. lanu-ginosus) or a variant of these. An example is Lipopan X (Lipopan Xtra), a variant of the Thermomyces lanuginosus lipase with the substitutions G91A+D96W+E99K+P256V+G263Q+L264A+I265T+G266D+T267A+L269N+270A+271 G+272G+273F (+274S), is described in W02004099400A2. Preferably, the lipase has at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to residues 1-316 or 1-273 of the amino acid sequence shown in SEQ ID NO:5 of international patent application WO2009/074650 (lipase/phospholipase from Fusarium oxysporum, described in EP 869167, available from Novozymes A/S, Denmark as Lipopan® F). Preferably, the lipase activity in the mash is 0-50 LU/g, such as 0-40 LU/g, such as 0-30 LU/g, such as 0-20 LU/g dry weight barley. In a another preferred embodiment of the invention, the lipase is Lipozyme TL or lipolase, this lipase has a significantly good effect on filtration speed and haze reduction. Thus in a preferred embodiment of the invention the lipase has at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to the amino acid sequence shown in SEQ ID NO 9 of international patent application WO2009/074650. The lipase may also be Lipex, a variant of Lipozyme. Thus, the lipase may be any lipase having at least 50%, more preferably at least 60%, more preferably at least 70%, more preferably at least 80%, more preferably at least 95%, more preferably at least 98%, and most preferably at least 99% or even 100% identity to the amino acid sequence shown in SEQ ID NO: 10 of international patent application WO2009/074650. The lipases degrade the lipid from barley e.g. the triglycerides, into partial glycerides and free fatty acids. This leads to a lower turbidity and much improved mash filtration and lautering properties. One Lipase Unit (LU) is the amount of enzyme which liberates 1 micromole of titrable butyric acid per minute at 30.0° C.; pH 7.0; with Gum Arabic as emulsifier and tributyrine as substrate.

### Exogenous Proteases

The methods of the invention comprise the use of at least two different exogenous proteases. It is preferred that at least one of said exogenous proteases is an endoprotease and the other is an exoprotease. Said exogenous proteases may be added at any suitable step of the methods of the invention, such as before mashing, at the beginning of mashing, during mashing, after heating of wort, at the onset of fermentation or during fermentation.

Endoproteases according to the present invention are enzymes capable of catalyzing the cleavage of a peptide bond connecting two amino acids, which are positioned internally in a polypeptide, i.e. not at the N or C-terminal ends.

Exopeptidases according to the present invention are enzymes capable of catalyzing the cleavage of a peptide bond connecting two amino acids, wherein at least one of these are positioned terminally in a polypeptide.

In one embodiment of the invention it is preferred that the proteases are heat stable.

In particular, it is preferred that said exogenous proteases are heat stable when added at any time prior to heating of the wort, e.g. if they are added before or during mashing.

It is preferred that said exogenous proteases are active at a pH corresponding to that of the beer (or mash or wort) to which it is added. In a preferred embodiment, the exogenous proteases have an acidic pH optimum, i.e. have a pH optimum of 6.0 or lower—for example a pH optimum of lower than 5, such as lower than 4, or even lower than 3. Said exogenous proteases may preferably be added before or during fermentation of wort.

In addition, it is preferred that one of the exogenous proteases is an endoprotease and more preferably that it is selected from the group of metalloprotease, proline-specific endo-proteases, or an endo-protease with glutamine specificity.

Thus in one preferred embodiment the endoprotease is a metalloprotease has at least 50%, more preferably at least 60%, more preferably at least 70%, more preferably at least 80%, more preferably at least 85%, more preferably at least 90%, more preferably at least 91%, more preferably at least 92%, more preferably at least 93%, more preferably at least 94%, more preferably at least 95% more preferably at least 96%, more preferably at least 97% more preferably at least 98%, and most preferably at least 99% or even 100% identity to the amino acid sequence shown in SEQ ID NO:1 (a metallo-protease from Bacillus amyloliquefaciens, described in WO9967370). Preferably the activity of this protease in the mash is 0.0005-0.002 AU/g, more preferably 0.001-0.0015 AU/g dry weight cereal(s). The proteolytic activity may be determined by using denatured hemoglobin as sub-strate. In the Anson-Hemoglobin method for the determination of proteolytic activity, denatured hemoglobin is digested, and the undigested hemoglobin is precipitated with trichloroacetic acid (TCA). The amount of the TCA soluble product is determined by using phenol reagent, which gives a blue color with tyrosine and tryptophan. One Anson Unit (AU) is defined as the amount of enzyme which under standard conditions (i.e. 25° C., pH 7.5 and 10 min. reaction time) digests hemoglobin at an initial rate such that there is liberated an amount of TCA soluble product per minute which gives the same colour with phenol reagent as one milliequivalent of tyrosine.

Thus, in another preferred embodiment the endoprotease is a proline-specific endoprotease. According to the present invention, proline-specific endoproteases are proteases capable of catalyzing cleavage of a peptide bond between a proline and a neighbouring amino acid, wherein said proline and said neighbouring amino acid are positioned internally in a polypeptide. More preferably, said proline-specific endoprotease is capable of catalyzing cleavage of a peptide bond between a proline and a neighbouring amino acid, wherein said proline is positioned more than 2 amino acids from either terminal end of the polypeptide and said neighbouring amino acid is positioned internally in a polypeptide. The proline-specific endoprotease is preferably capable of catalyzing hydrolysis of said peptide bond at the carboxy-terminal end of proline residues in which case one product of a said proline-specific endoprotease is a polypeptide with a C-terminal proline residue.

The proline-specific endoprotease may be the Aspergillus niger-derived prolyl endoprotease reported in J. Agic Food Chem. (Vol 53 (20), 7950-7957, 2005), the proline-specific endoprotease of Aspergillus described in European patent application EP 0 522 428, the proline-specific endoprotease of Flavobacterium described in European patent application EP 0 967 285, the proline-specific endoprotease from Penicillium chrysogenium described in WO2009/144269 or the proline-specific endoprotease from Aeromonas described by Kanatani et al., 1993 J. Biochem. (113(6): 790-796).

A useful proline-specific endoprotease that catalyzes cleavage of polypeptides/peptides at the NH2-terminus of a proline-residue is, for example, described in a publication in Nature of 15 Jan. 1998, Vol. 391, p. 301-304.

As is typical for enzyme activities, the activity of proline-specific endoproteases is dependent on the pH. In one preferred embodiment of the invention the proline-specific endoprotease has a maximum prolyl endoprotease activity at a pH which corresponds to the pH of the beer (or mash or wort) to which it is added. In a preferred embodiment of the method according to the invention, the proline-specific endoprotease has an acidic pH optimum, i.e. a pH optimum of 6.0 or lower—for example a pH optimum of in the range of 3 to 6, such as in the range of 4 to 6.

The proline-specific protease of the invention may in a preferred embodiment be isolated from one of the above-mentioned microbial species, and more preferably from a species of Aspergillus. Preferably, the proline-specific endoprotease is isolated from a strain of Aspergillus niger. Interestingly, the Aspergillus enzyme is optimally active around pH 5. The proline-specific endoprotease may also be isolated from an Aspergillus niger host engineered to overexpress a gene encoding a proline-specific endoprotease, although other hosts, such as E. coli are suitable hosts. For example, the cloning and overproduction of the Flavobacterium-derived proline-specific endoprotease in, amongst others, E. coli has made certain proline-specific endoproteases available in a pure form. An example of such an overproducing construct is provided in the World Journal of Microbiology and Biotechnology, Vol 11, pp 209-212. An Aspergillus niger host is preferably used in self cloning to drive the expression of a gene encoding an A. niger proline-specific endoprotease. Very preferably, the proline-specific endoprotease is the endoprotease as disclosed in European patent application EP1326957.

Thus, in one embodiment of the invention, the proline-specific endoprotease is an enzyme with proline specific endoprotease activity having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to the endoprotease from Aspergillus niger, available as Brewers Clarex® from DSM Food specialities, Netherlands.

In another embodiment the proline-specific endoprotease is derived from Penicillium chrysogenum. Preferably said proline-specific endoprotease has a pH optimum in the range of 4 to 5.

Thus, in one embodiment of the invention the proline-specific endoprotease is an enzyme with proline specific endoprotease activity having a pH optimum of in the range of 4 to 5 having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to the amino acid sequence shown in SEQ ID NO 3 of international patent application WO2009/144269.

In another embodiment of the invention one exogenous protease is a protease having glutamine endoprotease activity, such as a glutamine-specific endoprotease.

According to the present invention, glutamine-specific endoproteases are proteases capable of catalyzing cleavage of a peptide bond between a glutamine and a neighbouring amino acid, wherein both said glutamine and said neighboring amino acid are positioned internally in a polypeptide/peptide. More preferably said glutamine specific endoprotease is capable of catalyzing cleavage of a peptide bond between a glutamine and a neighboring amino acid, wherein said glutamine is positioned more than 2 amino acids from either end and said neighboring amino acid is positioned internally in a polypeptide/peptide. The glutamine-specific endoprotease is preferably capable of catalysing hydrolysing said peptide bond at the carboxy-terminal end of proline residues in which case one product of a said glutamine specific endoprotease is a peptide/polypeptide with a C-terminal glutamine.

In a preferred embodiment, the glutamine-specific endoprotease is a protease with cysteine-type endoprotease activity. Glutamine-specific endoproteases with cysteine-type endoprotease activity may preferably be any enzyme capable of catalyzing the hydrolysis of internal, alpha-peptide bonds between a glutamine and another amino acid in a polypeptide chain by a mechanism in which the sulfhydryl group of a cysteine residue at the active center of said endoprotease acts as a nucleophile. It is also preferred that the glutamine-specific endoprotease belongs to the peptidase C1 family.

Glutamine specific endoproteases to be used with the present invention may be derived from a variety of organisms, such as vertebrates, plants or microorganisms. In a preferred embodiment of the invention the glutamine specific endoprotease to be used with the invention is derived from a plant, preferably from a cereal and more preferably from barley.

Accordingly, it is preferred that one exogenous protease to be used with the present invention is barley glutamine-specific endoprotease, such as barley endoprotease A (EP-A) or barley endoprotease B (EP-B). Because said proteases are barley proteases, endogenous EP-A and EP-B may be present during mashing and in wort. However, it should be noted that only very little endogenous active EP-A and EP-B is present during mashing and even less is present in wort after heating. Thus, depending of pH, only about 1% of the potential EP-A and EP-B activity is detected during mashing [Riis, P., EBC Congress Dublin, 2003, pp 867-874 (presentation no. 84)]. Thus, even if some endogenous EP-A and EP-B may be present, the exogenous protease may also be EP-A and EP-B. The exogenous EP-A is preferably at least partly purified, more preferably purified EP-A, which may be added at any convenient time during the method. Similarly, exogenous EP-B is preferably at least partly purified, more preferably purified EP-B, which may be added at any convenient time during the method.

Thus, in one embodiment of the invention, the glutamine-specific endoprotease is an enzyme with glutamine specific endoprotease activity having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to a sequence having the UniProt identity 04675_HORVU.

In another embodiment of the invention, the glutamine-specific endoprotease is an enzyme with glutamine specific endoprotease activity having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to sequence having UniProt identifier P25250.

It is preferred that one of the exogenous proteases is an enzyme with exopeptidase activity. Said enzyme with exopeptidase activity may be an aminopeptidase or a carboxypeptidase. In particular, it is preferred that one of the exogenous proteaseases has carboxypeptidase activity.

In one preferred embodiment, the exopeptidase is an amino peptidase.

Amino peptidases are proteases and are classified under the Enzyme Classification number E.C. 3.4.11. They are capable of removing one or more amino terminal residues from polypeptides.

In one preferred embodiment, the aminopeptidase is an amino peptidase disclosed in WO96/28542.

In one embodiment, the amino peptidase is an aminopeptidase that is having a sequence with at least 60% such as at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to SEQ ID NO: 2.

Carboxypeptidases according to the present invention are enzymes capable of catalyzing the cleavage of a peptide bond connecting two amino acids, wherein at least one of these are positioned at the C-terminal end of a polypeptide or a peptide.

The carboxypeptidase may for example be selected from the group consisting of lysosomal Pro-Xaa carboxypeptidase (EC 3.4.16.2), serine-type D-Ala-D-Ala carboxypeptidase (EC 3.4.16.4), carboxypeptidase C (EC 3.4.16.5), carboxypeptidase D (EC 3.4.16.6), carboxypeptidase A (EC 3.4.17.1), carboxypeptidase B (EC 3.4.17.2), lysine carboxypeptidase (EC 3.4.17.3), Gly-Xaa carboxypeptidase (EC 3.4.17.4), alanine carboxypeptidase (EC 3.4.17.6), muramoylpentapeptide carboxypeptidase (EC 3.4.17.8), carboxypeptidase E (EC 3.4.17.10), glutamate carboxypeptidase (EC 3.4.17.11), carboxypeptidase M (EC 3.4.17.12), muramoyltetrapeptide carboxypeptidase (EC 3.4.17.13), zinc D-Ala-D-Ala carboxypeptidase (EC 3.4.17.14), carboxypeptidase A2 (EC 3.4.17.15), membrane Pro-Xaa carboxypeptidase (EC 3.4.17.16), tubulinyl-Tyr carboxypeptidase (EC 3.4.17.17), carboxypeptidase T (EC 3.4.17.18), carboxypeptidase Taq (EC 3.4.17.19), carboxypeptidase U (EC 3.4.17.20), glutamate carboxypeptidase II (EC 3.4.17.21), metallocarboxypeptidase D (EC 3.4.17.22), angiotensin-converting enzyme 2 (EC 3.4.17.23) and cathepsin X (EC 3.4.18.1).

The carboxypeptidase may also be any of the aforementioned, wherein said carboxypeptidase has been modified by recombinant technology. In particular the carboxypeptidase may be any of the aforementioned modified as described in U.S. Pat. No. 6,187,579.

In one preferred embodiment of the invention, one exogenous protease is carboxypeptidase Y, more preferably yeast carboxypeptidase Y. The exogenous protease may also be modified CPD-Y, in particular yeast carboxypeptidase Y modified as described in U.S. Pat. No. 6,187,579 and more preferably the modified CPD-Y as defined in any one of claims 1 to 17 therein or the modified CPD-Y as defined in any one of claims 1 to 16 of U.S. Pat. No. 5,945,329.

In another preferred embodiment of the invention, one exogenous protease is selected from the group consisting of carboxypeptidase MI (CPD-MI), carboxypeptidase MII (CPD-MII), carboxypeptidase MIII (CPD-MIII) and CPD-Y.

Thus, the exogenous protease may in one embodiment of the invention be a carboxypeptidase which is capable of catalysing cleavage of a C-terminal amino acid of a polypeptide with broad specificity, such as an enzyme classified under EC 3.4.16.5. More preferably, said carboxypeptidase is capable of catalysing cleavage of a C-terminal amino acid residue of a polypeptide, wherein said C-terminal amino acid residue is Pro. It is furthermore preferred that said carboxypeptidase in addition is capable of catalysing cleavage of other C-terminal amino acids of a polypeptide. Thus, in a preferred embodiment it is preferred that said carboxypeptidase is capable of catalysing cleavage of a C-terminal Pro of a polypeptide, and in addition is capable of catalysing cleavage of one or more C-terminal amino acids from a polypeptide selected from the group consisting of Ala, Val, Ile, Met, Phe and Ser. In particular it is preferred that said carboxypeptidase is a capable of catalysing cleavage of a C-terminal Pro of a protein or peptide, wherein the kcat/Km of said cleavage is at least 1000, preferably at least 1500, more preferably at least 2000 min-1 mM-1.

Accordingly, a very preferred exogenous protease to be used with the present invention is a carboxypeptidase, wherein said carboxypeptidase preferably may be CPD-MI, and more preferably barley CPD-MI. Barley CPD-MI may hydrolyse a C-terminal proline residue of a protein or peptide with a kcat/Km=2,600 min-1 mM-1 (Degan, F. D. et al., Appl. Environm. Microbiol. 58, pp. 2144-2152, 1992). When a terminal Pro residue is released from a protein or peptide by the action of CPD-MI, then the newly exposed residue can easily be hydrolysed by a number of different carboxypeptidases, such as a carboxypeptidase selected from the group consisting of CPD-MI, CPD-MII, CPD-MIII and CDP-Y.

Thus the exogenous protease may be any carboxypeptidase having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to sequence having UniProt identifier P07519.

In another embodiment the exogenous protease may be a carboxypeptidase which is capable of catalysing cleavage of a C-terminal amino acid with a positively charged side chain. In particular, said carboxypeptidase may be a carboxypeptidease capable of catalysing release of a C-terminal Arg or Lys residue from a polypeptide with significantly larger efficiency than other C-terminal amino acids. Said significantly larger efficiency preferably means at least twice, preferably at least 3 times, such as at least 4 times more efficiently. Thus, said carboxypeptidase may be an enzyme according to EC 3.4.16.6.

Such a carboxypeptidase may preferably be carboxypeptidase MII, more preferably barley carboxypeptidase MII. Thus the exogenous protease may be any carboxypeptidase having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to sequence having UniProt identifier P08818.

In another embodiment the exogenous protease may be a carboxypeptidase which is capable of catalysing cleavage of a C-terminal amino acid with an aromatic side chain from a polypeptide, such as Phe. In addition it is preferred that such a carboxypeptidase also is capable of catalysing cleavage of other C-terminal amino acids from a polypeptide. Such a carboxypeptidase may preferably be carboxypeptidase MIII, more preferably barley carboxypeptidase MIII. Thus the exogenous protease may be any carboxypeptidase having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to sequence having UniProt identifier P21529.

Thus, the exogenous protease may in one embodiment of the invention be a carboxypeptidase which is capable of catalysing cleavage of a C-terminal amino acid from a polypeptide with broad specificity, such as a carboxypeptidase according to EC 3.4.16.5. In particular it is preferred that said carboxypeptidase is capable of catalysing cleavage of a C-terminal amino acid from a polypeptide, wherein said C-terminal amino acid may, for example, be selected from the group consisting of, Ala, Val, Ile, Met, Phe, Arg and Ser. Such a carboxypeptidase may preferably be carboxypeptidase Y, more preferably yeast carboxypeptidase Y, even more preferably carboxypeptidase Y of Saccharomyces cerevisiae. The specificity of yeast CPD-Y is for example described in Degan et al., 1992, Applied and Environmental Microbiology, 58(7): 2144-2152. Thus the exogenous protease may be any carboxypeptidase having a sequence with at least 70%, more preferably at least 80%, more preferably at least 85%, more preferably at least 90%, more preferably at least 91%, more preferably at least 92%, more preferably at least 93%, more preferably at least 94%, more preferably at least 95%, more preferably at least 96%, more preferably at least 97% more preferably at least 98%, and most preferably at least 99% or even 100% identity to sequence having UniProt identifier P00729.

In certain embodiments of the invention, and in particular in such embodiments of the invention, wherein one exogenous protease is a proline-specific endoprotease, then it is preferred that at least one other exogenous protease is a carboxypeptidase capable of catalysing cleavage of a C-terminal proline. Such carboxypeptidases may for example be selected from the group consisting of CPD-MI and CPD-Y, more preferably said carboxypeptidase may be CDP-MI, and even more preferably barley CDP-MI.

In certain embodiments of the invention and in particular in such embodiments of the invention, wherein one exogenous protease is a glutamine-specific endoprotease, then it is preferred that at least one other exogenous protease is a carboxypeptidase capable of catalysing cleavage of a C-terminal glutamine. Such carboxypeptidases may for example be selected from the group consisting of CPD-MI and CPD-Y, more preferably from the group consisting of barley CDP-MI and yeast CDP-Y.

In certain embodiments of the invention the endoprotease is a Neutrase® and the exopeptidase is amino peptidase AP1.

In certain other embodiments of the invention the endoprotease is a Neutrase® and the exopeptidase is amino peptidase AP1 and the exopeptidase XDPAP.

The first step of producing beer from wort preferably involves heating said wort as described herein above, followed by a subsequent phase of wort cooling and optionally whirlpool rest. After being cooled, the wort is transferred to fermentation tanks containing yeast. Preferably, said yeast is brewer's yeast, Saccharomyces carlsbergensis. The wort will be fermented and matured for any suitable time period, in general in the range of 1 to 100 days. During the several-day-long fermentation process, sugar is converted to alcohol and CO2 concomitantly with the development of some flavor substances.

Accordingly, the method according to the invention preferably comprises a step of incubating barley wort, which may be any wort as described herein. This step is preferably undertaken subsequent to heating of the wort. Said exogenous proteases may in a preferred embodiment of the invention be added before or during said incubation with yeast, preferably they are added at the onset of said incubation with yeast.

Said yeast may be any useful yeast capable of fermenting said wort, such as brewers yeast, e.g. Saccharomyces carlsbergensis.

As described herein above the wort prepared according to the methods of the invention is especially useful for supporting yeast growth. Accordingly, it is possible according to the methods of the invention to have a reduced fermentation time. Thus it is preferred that the incubation with yeast is performed for at the most 15 days, such as at the most 10 days.

After preparing the beer, the beer may be further processed, for example chilled. It may also be filtered and/or lagered a process that develops a pleasant aroma and a less yeasty flavour. Also additives may be added. Furthermore, CO2 may be added. Finally, the beer may be pasteurized and/or filtered, before it is packaged (e.g. bottled or canned).

### EXAMPLES

The examples herein illustrate preferred embodiments of the invention and should not be considered as limiting for the invention.

Unless otherwise indicated, basic molecular biological techniques were performed for manipulating nucleic acids and bacteria as described in Sambrook and Russel (2001).

### Example 1

Levels of free amino acids were determined in 50-μl samples of either wort or beer. The amino acid analysis was performed in accordance with the recommendations of the UPLC Amino Acid Analysis Application Solution provided by Waters, United States. The analysis was undertaken using the AccQ Tag Ultra Derivatization Kit (available from Waters, United States), according to the manufacturer's instructions. All equipment used including instruments, chemicals and kits were obtained from Waters, United States. Amino acid concentrations were calculated by comparing peak areas obtained from the UPLC with amino acid standards.

The levels of individual amino acids were determined in two different commercially available beers, namely Carlsberg Pilsner (available from Carlsberg Breweries, Denmark), which is a beer prepared from malt, and Clim8 Beer (available from Harboe, Denmark), which is a beer prepared from barley in the absence of malt. Clim8 Beer is prepared using the enzyme mixture Ondea Pro available from Novozymes A/S, Denmark.

The results are shown in Table 1. As is apparent, the level of all amino acids is higher in the malt based beer compared to the barley-brewed beer, and the overall level is more than 12 times higher in the malt-based beer compared to the barley-brewed beer. Significantly, the level of Val is much higher in the malt based beer compared to the barley brewed beer.

TABLE 1
Comparison of commercial beers

| | | Concentration of free amino acids | |
|---|---|---|---|
| | | Malt-brewed beer | Barley-brewed beer |
| | | (Carlsberg Pilsner) | (Clim8 Beer) |
| | | mg/L | |
| Alanine | Ala | 135 | 6 |
| Arginine | Arg | 83 | 3 |
| Asparagine | Asn | 7 | 2 |
| Aspartic acid | Asp | 25 | 0 |
| Cysteine | Cys | 6 | 6 |
| Glutamine | Gln | 17 | 3 |
| Glutamic acid | Glu | 47 | 2 |
| Glycine | Gly | 36 | 6 |
| Histidine | His | 35 | 2 |
| Isoleucine | Ile | 32 | 1 |
| Leucine | Leu | 70 | 3 |
| Lysine | Lys | 17 | 0 |
| Methionine | Met | 11 | 2 |
| Phenylalanine | Phe | 82 | 4 |
| Proline | Pro | 380 | 45 |
| Serine | Ser | 5 | 1 |
| Threonine | Thr | 3 | 1 |
| Tryptophan | Trp | 40 | 4 |
| Tyrosine | Tyr | 95 | 5 |
| Valine | Val | 91 | 2 |
| Total | | 1217 | 98 |
| | | (~10 mM) | (~1 mM) |

### Example 2

### Effect of a Combination of Endo-Protease and Exo-Peptidases on the Free Amino Acid Content

### Enzymes:

Ondea Pro available from Novozymes A/S, Denmark, endoprotease of Seq ID No:1, and an exopeptidase which is an aminopeptidase of SEQ ID No:2 were used to test the effect of combining endoprotease with exopeptidases on the free amino acid content.

Ondea Pro contains an endoprotease.

The enzymes were added in different concentrations—see Table 2.

### Mashing:

50 g grinded barley (gap 0.2 mm) was added to a beaker together with 200 ml H₂O (54° C.), 3 ml CaCl₂.H₂O (11 g/500 ml) and endo-protease and exo-peptidases were added according to Table 1. Following mashing was made using a Lochner LB Electronic Mashing device:
54° C. for 30 min
64° C. for 60 min
80° C. for 10 min
20° C.

The mixtures were adjusted to 300 g with water and the wort was filtered using a whatman filter 597%.

TABLE 2
Addition of Ondea Pro, endoprotease and exopeptidase to mashing

| | Ondea Pro | | |
|---|---|---|---|
| | (kg enzyme | Endoprotease of | Aminopeptidase |
| | product/ton | SEQ ID NO: 1 | of SEQ ID NO: 2 |
| Sample | barley) | (AU/g barley) | (mg EP/kg barley) |
| 1 | 1 | 0 | 0 |
| 2 | 1 | 0.0005 | 0 |
| 3 | 1 | 0 | 4 |
| 4 | 1 | 0 | 0 |
| 5 | 1 | 0 | 4 |
| 6 | 1 | 0 | 8 |
| 7 | 1 | 0 | 0 |
| 8 | 1 | 0 | 8 |

EP: enzyme protein

### Free Amino Nitrogen (FAN)

Free amino nitrogen (FAN) was measured in the wort samples with a Skalar SAN++ system according to manufacturer's protocol (Skalar methods; Catnr. 149-203) (Table 3).

Addition of endoprotease or aminopeptidase both resulted in an increased amount of FAN (up to 102 mg/L) compared to sample 1 with only Ondea Pro (84.94 mg/L).

TABLE 3
Amount of FAN in wort samples

| Sample | Enzymes added | FAN (mg/L) |
|---|---|---|
| 1 | Ondea Pro | 84.94 |
| 2 | Ondea Pro + endoprotease of SEQ ID NO: 1 | 102.03 |
| 3 | Ondea Pro + Aminopeptidase of SEQ ID NO: 2 | 97.51 |
| | (L) | |
| 8 | Ondea Pro + Aminopeptidase of SEQ ID NO: 2 | 101.93 |
| | (H) | |

L: low concentration (=4 mg EP/kg);
H: high concentration (=8 mg EP/kg)

### Free Amino Acid Analysis

The amount of the different free amino acids (FAA) was measured by Dionex summit HPLC according to manufacturer's protocol. A Gemini® 3 μm C18 110 Å column from Phenomenex was used, and OPA reagent, FMOC reagent and Borate buffer were obtained from Agilent Technologies and used for derivatization. The wort samples were diluted 5 times before use. The amino acid concentrations were calculated comparing peak areas obtained from the HPLC with amino acid standards. The amino acid standards were obtained from Sigma (AAS18) containing 17 out of 20 amino acids. For the remaining three (Asn, Gln and Trp), 2.5 mM solution in 0.1N HCl were made. The amount of cysteine was not measured.

Similar to the FAN measurements, addition of extra endo protease and/or aminopeptidase increased the amount of FAA. (Table 4).

TABLE 4
Concentration (mg/L) of the different amino acids in wort

| | | | Sample 3 | |
|---|---|---|---|---|
| | | | Ondea Pro + | Sample 8 |
| | | | Amino- | Ondea Pro + |
| | | Sample 2 | peptidase | Amino- |
| | Sample 1 | Ondea Pro + | of | peptidase |
| | Ondea | endoprotease | SEQ ID | of SEQ ID |
| AA | Pro | of SEQ ID NO: 1 | NO: 2 (L) | NO: 2 (H) |
| Asp | 34.75 | 36.95 | 31.49 | 36.50 |
| Glu | 26.32 | 32.09 | 26.45 | 27.97 |
| Asn | 43.10 | 45.36 | 43.69 | 46.56 |
| Ser | 19.07 | 25.00 | 19.19 | 19.02 |
| Gln | 21.72 | 28.32 | 22.13 | 22.45 |
| His | 15.30 | 18.48 | 17.87 | 20.57 |
| Gly | 9.50 | 11.19 | 9.39 | 8.05 |
| Thr | 21.24 | 26.04 | 28.70 | 35.28 |
| Arg | 52.78 | 66.10 | 55.94 | 57.06 |
| Ala | 37.34 | 44.50 | 38.20 | 39.07 |
| Tyr | 29.32 | 36.56 | 30.49 | 32.74 |
| Val | 29.85 | 35.00 | 56.62 | 70.36 |
| Met | 16.23 | 20.78 | 18.93 | 19.52 |
| Trp | 19.24 | 21.16 | 20.57 | 22.10 |
| Phe | 36.62 | 44.73 | 43.99 | 48.47 |
| Ile | 16.61 | 19.45 | 35.11 | 44.22 |
| Leu | 53.05 | 65.02 | 93.72 | 99.78 |
| Lys | 64.06 | 79.12 | 66.17 | 68.45 |
| Pro | 58.99 | 66.98 | 55.35 | 58.12 |
| Total | 605.08 | 722.85 | 714.02 | 776.28 |
| Total (mM) | 4.54 | 5.42 | 5.37 | 5.84 |

The addition of an exopeptidase together with Ondea Pro resulted in increase of specific amino acids (valine, leucine, and isoleucine). In contrast, addition of extra endoprotease together with Ondea Pro resulted in an overall increase of all amino acids.

1-13. (canceled)

14. A method of preparing a wort comprising a high level of free amino acids, said method comprising the steps of
a) mashing a composition comprising barley in the presence of exogenous enzymes comprising an alpha amylase, a beta glucanase, a pullulanase, a xylanase, and a lipase; and
b) adding to said composition during mashing or after completion of mashing at least two different exogenous proteases, wherein one protease has endoprotease activity, and the other protease has exopeptidase activity.

15. The method of claim 14, wherein the exogenous proteases are added to the wort.

16. The method of claim 14, wherein the protease having endoprotease activity is a metalloprotease.

17. The method of claim 16, wherein the metalloprotease is a protease having at least 60% identity to SEQ ID NO: 1.

18. The method of claim 16, wherein the metalloprotease is a protease having at least 80% identity to SEQ ID NO: 1.

19. The method of claim 16, wherein the metalloprotease is a protease having at least 90% identity to SEQ ID NO: 1.

20. The method of claim 14, wherein the protease having endoprotease activity is a proline and/or a glutamine specific endoprotease.

21. The method of claim 14, wherein the protease having exopeptidase activity has proline specific activity.

22. The method of claim 14, wherein the protease having exopeptidase activity has a carboxyproline specific activity.

23. The method of claim 14, wherein the protease with exopeptidase activity is an aminopeptidase.

24. The method of claim 23, wherein the aminopeptidase is a protease having 60% identity to SEQ ID NO: 2.

25. The method of claim 14, wherein the protease with exopeptidase activity is a carboxypeptidase.

26. The method of claim 14, wherein said wort after incubation with said proteases comprises a high level of group B amino acids.

27. The method of claim 26, wherein the amino acids are valine, leucine and/or isoleucine.

28. The method of claim 14, wherein the wort has an amino acid level of at least 3 mM free amino acids.


SEQUENCE LISTING (2 sequences)

SEQ ID NO: 1 - protein, 300 aa, B.amyloliquefaciens
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 2 - protein, 298 aa, A.oryzae
YPDSVQHNETVQNLIKSLDKKNFETVLQPFSEFHNRYYKSDNGKKSSEWLQGKIQEIISASGAKGVTVEPFKHSFPQSSLIAKIPGKSDKTIVLGAHQDSINLDSPSEGRAPGADDDGSGVVTILEAFRVLLTDEKVAAGEAPNTVEFHFYAGEEGGLLGSQDIFEQYSQKSRDVKAMLQQDMTGYTKGTTDAGKPESIGIITDNVDENLTKFLKVIVDAYCTIPTVDSKCGYGCSDHASATKYGYPAAFAFESAFGDDSPYIHSADDTIETVNFDHVLQHGKLTLGFAYELAFADSL